(19) United States
(12) Patent Application Publication
(10) Pub. No.: US 2008/0284712 A1
(43) Pub. Date: Nov. 20, 2008

(54) Display driver and electronic equipment

(75) Inventors: Kota Muto, Suwa (JP); Munenori Sawada, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/890,198

(22) Filed: Aug. 3, 2007

(30) Foreign Application Priority Data
Aug. 4, 2006 (JP) 2006-212780
Aug. 17, 2006 (JP) 2006-222567
Jun. 7, 2007 (JP) 2007-151834

(51) Int. Cl. G09G 3/36

(52) U.S. Cl. 345/101

(57) ABSTRACT

A display driver for driving a display element includes an electro-optical layer to which a drive voltage is applied, the drive voltage being a voltage corresponding to a scanning voltage and a data voltage, the scanning voltage being a voltage applied to a scanning electrode, the data voltage being a voltage applied to a data electrode. The display driver includes: a display driver circuit configured to apply the drive voltage to the electro-optical layer, the drive voltage corresponding to one of at least two operation modes including a first drive mode and a second drive mode, the first drive mode having a first temperature range for representing two tones, the second drive mode having a second temperature range for representing two tones, the first temperature range and the second temperature range being different from each other; an input interface configured to input temperature information, the temperature information being information relating to temperature of the display element; and an operation mode determining unit configured to determine operation mode of the display driver circuit on the basis of the temperature information.

The entire disclosures of Japanese Patent Applications No. 2006-212780 filed on Aug. 4, 2006, No. 2006-222567 filed on Aug. 17, 2006, and No. 2007-151834 filed on Jun. 7, 2007 are expressly incorporated by reference herein.

### BACKGROUND

1. Technical Field

The present invention relates to compensating temperature dependency during driving of a display element having image-retaining (bistable) liquid crystal.

2. Related Art

Image-retaining (bistable) liquid crystal such as cholesteric liquid crystal is used as a display medium suitable for a device such as a so-called electronic book or electronic paper. The cholesteric liquid crystal has an advantage in that it can maintain a display without application of a voltage. However, the cholesteric liquid crystal has a demerit in that the rewriting rate of the cholesteric liquid crystal is slower than the conventional liquid crystal. DDS (Dynamic Drive Scheme) is known as a technology by which the rewriting rate of the cholesteric liquid crystal is improved. According to the DDS, the orientation states of the cholesteric liquid crystal is determined on the basis of an electric power provided to the cholesteric liquid crystal during a so-called “selection phase”. A voltage applied during the selection phase is referred to as a “selection voltage”.

### SUMMARY

The relationship between the selection voltage and the reflectance of the liquid crystal is affected by temperature. FIG. 8 schematically shows temperature dependency of reflectance—selection voltage curve. In FIG. 8, the horizontal axis represents selection voltages while the vertical axis represents reflectance. Here, the reflectance shows a relative brightness, assuming that a reflective brightness of a standard white plate as a reference is 100%. The cholesteric liquid crystal appears closer to white with increased reflectance, while the cholesteric liquid crystal appears closer to black with decreased reflectance. To a pixel whose tone is black, a voltage V₁, which is black selection voltage, is applied. To a pixel whose tone is white, a voltage V₂, which is a white selection voltage, is applied. FIG. 8 shows an example of drive parameters which are optimized for 25° C. For example, at 29° C., by applying white selection voltage V₂, the reflectance of the cholesteric liquid crystal corresponds to not white, but black. This means the system cannot perform normal display at 29° C. On the contrary, in a temperature range of 24-26° C., by application of the white selection voltage V₂, the reflectance corresponds to white, and application of the black selection voltage V₁, the reflectance corresponds to white. In this temperature range, the system can display white and black correctly. In this case, a temperature margin is 24-26° C. Here, the term “temperature margin” refers to a temperature range in which the system can display correctly black and white.

To expand the temperature margin, there is known an approach of making the black selection voltage lower and the white selection voltage higher. However, this approach has three problems. (i) The first problem is a problem caused by a passive matrix system. Since the cholesteric liquid crystal is driven by a so-called passive matrix system, a voltage of (V₂−V₁)/2 is applied to a pixel during the non-selection phase. In other words, if the black selection voltage becomes lower and the white selection voltage becomes higher, a voltage which is applied to a pixel is increased. If the voltage is greater than a threshold at which the liquid crystal responds, a pixel is rewritten during the non-selection phase. Even if the voltage is below the threshold, the increase of the voltage during the non-selection phase causes the reflectance during the non-selection phase to decrease. Then, if power is not supplied, the reflectance recovers. Thus, if successive updates of the display are performed, the reflectance decreases and recovers repeatedly. This phenomenon is referred to as a “flashing problem”. (ii) The second problem is a problem of electric power consumption. As described above, the increase in the white selection voltage causes a voltage during the non-selection phase to increase. This means an increase in power consumption. (iii) The third problem is a problem of multi-level tone display. The extent of gradation (or number of tones) which a pixel can represent depends on a number of steps of PWM (Pulse Width Modulation). The number of steps of PWM depends on a number of bits of input data of a display driver. The increase of the range of the selection voltage means an increase of width of a PWM step. In other words, the voltage control becomes more imprecise.

The invention provides technology for preventing harmful effects caused by the expansion of the temperature margin.

According to one aspect of the invention, there is provided a display driver for driving a display element including an electro-optical layer to which a drive voltage is applied, the drive voltage being a voltage corresponding to a scanning voltage and a data voltage, the scanning voltage being a voltage applied to a scanning electrode, the data voltage being a voltage applied to a data electrode, the display driver including: a display driver circuit configured to apply the drive voltage to the electro-optical layer, the drive voltage corresponding to one of at least two operation modes including a first drive mode and a second drive mode, the first drive mode having a first temperature range for representing two tones, the second drive mode having a second temperature range for representing two tones, the first temperature range and the second temperature range being different from each other; an input interface configured to input temperature information, the temperature information being information relating to temperature of the display element; and an operation mode determining unit configured to determine operation mode of the display driver circuit on the basis of the temperature information. According to the display driver, the operation mode of the display driver circuit is determined on the basis of the temperature information.

It is preferred that the temperature information includes temperature dispersion showing a dispersion of temperature within a predetermined area of the display element. According to the display driver, the operation mode of the display driver circuit is determined on the basis of the temperature dispersion.

It is also preferred that the second temperature range is wider than the first temperature range; the display driver further includes a condition determining unit configured to determine whether the temperature dispersion included in the temperature information is greater than a threshold; and the operation mode determining unit is configured to determine that the operation mode of the display driver circuit is the second drive mode in a case that the condition determining unit determines that the temperature dispersion is greater than the threshold. According to the display driver, the operation mode of the display driver circuit is determined to be the second drive mode in a case that the temperature dispersion is greater than the threshold.

It is also preferred that the maximum temperature in the second temperature range is greater than that in the first temperature range; the display driver further includes a condition determining unit configured to determine whether the temperature dispersion included in the temperature information satisfies a condition, the condition showing the temperature dispersion is higher than a threshold and temperature of a region where the temperature dispersion is higher than the threshold is higher than the temperature of the periphery of the region; and the operation mode determining unit is configured to determine that the operation mode of the display driver circuit is the second drive mode in a case that the condition determining unit determines that the temperature dispersion satisfies the condition. According to the display driver, the operation mode of the display driver circuit is determined to be the second drive mode in a case that the temperature dispersion is higher than a threshold and temperature of a region where the temperature dispersion is higher than the threshold is higher than the temperature of the periphery of the region.

It is also preferred that the minimum temperature in the second temperature range is less than that in the first temperature range; the display driver further includes a condition determining unit configured to determine whether the temperature dispersion included in the temperature information satisfies a condition, the condition showing the temperature dispersion is higher than a threshold and temperature of a region where the temperature dispersion is higher than the threshold is lower than the temperature of the periphery of the region; and the operation mode determining unit is configured to determine that the operation mode of the display driver circuit is the second drive mode in a case that the condition determining unit determines that the temperature dispersion satisfies the condition. According to the display driver, the operation mode of the display driver circuit is determined to be the second drive mode in a case that the temperature dispersion is higher than a threshold and temperature of a region where the temperature dispersion is higher than the threshold is lower than the temperature of the periphery of the region.

It is also preferred that the display driver further includes: an IR information input interface configured to input IR information showing an intensity of infrared rays irradiated onto the display element; and a condition determining unit configured to determine whether the IR intensity included in the IR information satisfies a condition, the condition showing that the IR intensity is higher than a predetermined threshold, wherein the maximum temperature of the second temperature range is higher than that in the first temperature range; and the operation mode determining unit is configured to determine that the operation mode of the display driver circuit is the second drive mode in a case that the condition determining unit determines that the IR intensity satisfies the condition. According to the display driver, the operation mode of the display driver circuit is determined to be the second drive mode in a case that the condition determining unit determines that the IR intensity is higher than a predetermined threshold.

It is also preferred that the display driver further includes: a standard temperature determining unit configured to determine a standard temperature, the standard temperature being standard on the basis of which the drive voltage is determined; and a parameter memory configured to store a plurality of parameter sets, each of the plurality of parameter set defining the drive voltage at a certain temperature in an operation mode, wherein the display driver circuit is configured to apply the drive voltage in accordance with one of the plurality of parameter sets, the one parameter set being determined on the basis of the standard temperature and the operation mode determined by the operation mode determining unit. According to the display driver, the parameter set to be used is determined on the basis of the standard temperature and the operation mode.

It is also preferred that the electro-optical layer includes image-retaining liquid crystal molecules that represent a tone in response to orientation state of the image-retaining liquid crystal molecules; the display driver circuit is configured to apply the drive voltage by dividing the drive voltage into a plurality of stages including a selection phase during which a selection voltage that determines the orientation state of the image-retaining liquid crystal molecules is applied, the range of the selection voltage in the first drive mode and in the second drive mode is different from each other. According to the display driver, the drive voltage is divided into a plurality of stages including a selection phase during which a selection voltage that determines the orientation state of the image-retaining liquid crystal molecules is applied.

It is also preferred that the temperature information includes temperature variation showing time dependency of the temperature of the display element. According to the display driver, the operation mode of the display driver circuit is determined on the basis of the temperature variation.

It is also preferred that the maximum temperature in the second temperature range is higher than that in the first temperature range; the display driver further includes a condition determining unit configured to determine whether the temperature variation included in the temperature information satisfies a condition, the condition showing that the temperature of the display element decreases; and the operation mode determining unit is configured to determine that the operation mode of the display driver circuit is the second drive mode in a case that the condition determining unit determines that the temperature variation satisfies the condition. According to the display driver, the operation mode of the display driver circuit is determined to be the second drive mode in a case that the temperature of the display element decreases.

It is also preferred that the minimum temperature in the second temperature range is lower than that in the first temperature range; the display driver further includes a condition determining unit configured to determine whether the temperature variation included in the temperature information satisfies a condition, the condition showing that the temperature of the display element increases; and the operation mode determining unit is configured to determine that the operation mode of the display driver circuit is the second drive mode in a case that the condition determining unit determines that the temperature variation satisfies the condition. According to the display driver, the operation mode of the display driver circuit is determined to be the second drive mode in a case that the temperature of the display element increases.

It is also preferred that the temperature information includes the temperature of the display element; the display driver further includes a threshold memory configured to store a threshold showing the temperature at which the operation mode is switched; the operation mode determining unit is configured to determine that the operation mode of the display driver circuit is the second drive mode in a case that the temperature shown by the temperature information is lower than the threshold. According to the display driver, the operation mode of the display driver circuit is determined to be the second drive mode in a case that the temperature shown by the temperature information is lower than the threshold.

According to another aspect of the invention, there is provided an electronic equipment, including: a display element including an electro-optical layer to which a drive voltage is applied, the drive voltage being a voltage corresponding to a scanning voltage and a data voltage, the scanning voltage being a voltage applied to a scanning electrode, the data voltage being a voltage applied to a data electrode, the display driver including: a display driver circuit configured to apply the drive voltage to the electro-optical layer, the drive voltage corresponding to one of at least two operation modes including a first drive mode and a second drive mode, the first drive mode having a first temperature range for representing two tones, the second drive mode having a second temperature range for representing two tones, the first temperature range and the second temperature range being different from each other; an input interface configured to input temperature information, the temperature information being information relating to temperature of the display element; and an operation mode determining unit configured to determine an operation mode of the display driver circuit on the basis of the temperature information. According to the electronic equipment, the operation mode of the display driver circuit on the basis of the temperature information.

It is preferred that the electronic equipment further includes: two glass substrates configured to sandwich the electro-optical layer; a plurality of temperature sensors mounted on a plane of at least one of the two glass substrates; at least one radiation sheet pasted on the same plane as the temperature sensors. According to the electronic equipment, the temperature sensor measures temperature of an area covered by a radiation sheet.

It is also preferred that the plurality of temperature sensors are laid out at intervals; the electronic equipment includes a plurality of radiation sheets, each of which covers at least one of the temperature sensors, and is arranged so as not to overlap each other. According to the electronic equipment, the temperature sensor measures temperature of an area covered by a radiation sheet which is not overlapping to other radiation sheet.

It is also preferred that the radiation sheet includes a graphite sheet. According to the electronic equipment, the temperature sensor measures temperature of an area covered by a graphite sheet.

It is also preferred that at least one of the temperature sensors is arranged at a position whose distance from the edge of the plane is greater than a threshold; some of the temperature sensors other than the at least one of the temperature sensors is arranged at a position whose distance from the edge of the plane is less than a threshold; and the temperature information shows temperature difference between the at least one of the temperature sensors and some of the temperature sensors. According to the electronic equipment, the operation mode of the display driver circuit on the basis of the temperature difference between the at least one of the temperature sensors and some of the temperature sensors.

### BRIEF DESCRIPTION OF THE DRAWINGS

The invention will be described with reference to the accompanying drawings, wherein like numbers refer to like units:

FIG. 1 shows a configuration of an information processing device 100 in accordance with the first embodiment;

FIG. 2 shows a configuration of the temperature sensor 150;

FIG. 3 shows a configuration of display element 140;

FIGS. 4A-4C show an orientation state of the cholesteric liquid crystal;

FIG. 5 shows a drive cycle of the DDS;

FIG. 6 shows transition of orientation states of cholesteric liquid crystal according to the DDS;

FIG. 7 shows an example of a drive voltage waveform according to the DDS;

FIG. 8 schematically shows reflectance—selection voltage curves of the cholesteric liquid crystal;

FIG. 9 shows a flowchart illustrating an operation of the information processing device 100;

FIG. 10 shows a configuration of an information processing device 200 in accordance with the second embodiment;

FIG. 11 shows a flowchart illustrating an operation of the information processing device 200;

FIG. 12 shows a configuration of an information processing device 300 in accordance with the third embodiment;

FIG. 13 is a flowchart showing an operation of the information processing device 300;

FIG. 14 schematically shows another example of reflectance—selection voltage curves;

FIG. 15 shows a configuration of an information processing device 400 in accordance with the fourth embodiment;

FIG. 16 is a flowchart showing an operation of the information processing device 400;

FIG. 17 schematically shows a lower side view of the display element 140;

FIG. 18 schematically shows a right side view of the display element 140; and

FIG. 19 shows another example of an arrangement of the radiation sheets.

### DESCRIPTION OF EXEMPLARY EMBODIMENTS

### 1. First Embodiment

1-1. Configuration

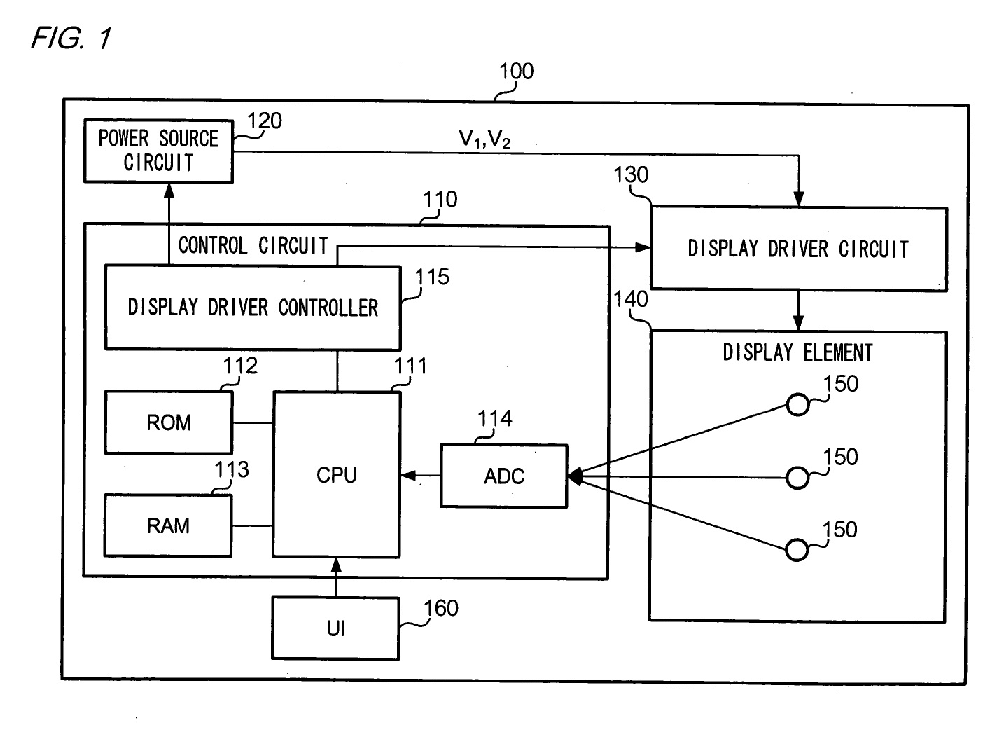

FIG. 1 shows a configuration of an information processing device 100 in accordance with the first embodiment. The information processing device 100 is electronic equipment that has a function to display a character or an image in response to inputted data. A control circuit 110 controls elements of the information processing device 100. A power source circuit 120 supplies power for driving a display element 140. A display driver circuit 130 outputs a signal for driving the display element 140, under the control of the control circuit 110. In other words, the display driver circuit 130 drives the display element 140. The display element 140 is a display element having an electro-optical layer. The display element 140 has plural temperature sensors 150. A temperature sensor 150 outputs a signal showing its temperature. UI 160 is a user interface by which a user inputs an instruction to the information processing device 100. The UI 160 includes, for example, a rewrite button to instruct the information processing device 100 to rewrite the display. Here, a combination of the control circuit and the display driver circuit 130 may be referred to as a “display driver”.

The control circuit 110 has the following configuration. A CPU (Central Processing Unit) 111 is an example of an operation mode determining unit and controls elements of the control circuit 110. A ROM (Read Only Memory) 112 is a memory that stores a program and data necessary to operate the control circuit 110. A RAM (Random Access Memory) 113 is a memory that functions as a work area when the CPU 111 executes a program. An ADC (Analog/Digital Converter) converts an analog signal outputted from the temperature sensor 150 into a digital signal. Thus, temperature information is inputted via the ADC 114. A display driver controller 115 controls the display driver circuit 130 on the basis of a temperature signal outputted from the ADC 114 and a control signal outputted from the CPU 111. Described in detail, the display driver controller 115 determines drive parameters such as a voltage value and a pulse width for driving the display element 140, on the basis of the temperature signal. The display driver controller 115 stores in its internal memory a table which includes a drive parameter set corresponds to a temperature. In other words, the table includes at least one data set, each of which includes a temperature and corresponding drive parameter set. The display driver circuit 130 can be operated in at least two operation modes, which includes a normal mode and a temperature prioritizing mode. The display driver circuit 130 stores a table in which a drive parameter set corresponds to a temperature for each operation mode. In other words, the display driver circuit 130 stores a drive parameter set for each standard temperature. A drive parameter set includes drive parameters for plural drive modes including the normal mode and the temperature prioritizing mode. The display driver circuit 130 uses one drive parameter set from among plural drive parameter sets. Each drive parameter set corresponds to a standard temperature. The display driver circuit 130 uses drive parameters corresponding to an operation mode. Details of the operation modes will be described later.

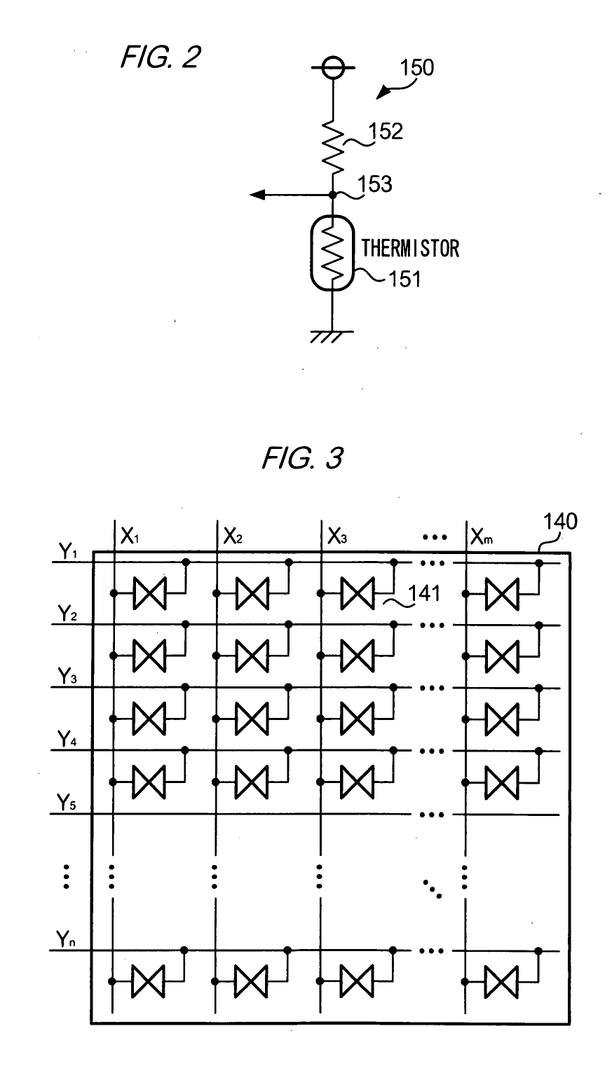

FIG. 2 shows a configuration of the temperature sensor 150. In the present embodiment, the temperature sensor 150 includes a thermistor 151. The thermistor 151 is a device whose resistance changes in response to its temperature. Specifically, the higher the temperature of the thermistor 151 becomes, the lower the resistance of the thermistor 151 becomes. A resistor 152 is connected serially to one terminal of the thermistor 151. The other terminal of the thermistor 151 is connected to the ground. The other terminal of the resistor 152 is connected to a voltage source. The electric potential of a point 153 which is between the thermistor 151 and the resistor 152 changes in response to a ratio of a resistance of the thermistor 151 to a resistance of the resistor 152. In other words, the voltage outputted from the temperature sensor 150 changes in response to its temperature.

FIG. 3 shows a configuration of display element 140. The display element 140 has an n×m matrix wiring which includes n rows of scanning electrodes (Y₁, Y₂, . . . , Yₙ) and m columns of data electrodes (X₁, X₂, . . . , Xₘ). In this case, n and m are positive integers. In the first embodiment, the display element 140 is a so-called passive matrix display element, and therefore, scanning and data electrodes can respectively function as scanning lines and data lines. At regions where the scanning and data electrodes intersect each other (corresponding to intersections between the scanning and data electrodes in FIG. 3), electro-optical elements 141 are formed. Each of the electro-optical elements 141 has two electrodes and an electro-optical layer sealed between the two electrodes (wherein the two electrodes are a data electrode (also called a pixel electrode or segment electrode) and a scanning electrode (also called a common electrode)). This embodiment employs, as the electro-optical layer, a liquid crystal layer including cholesteric liquid crystal, which is an example of an image-retaining liquid crystal. The image-retaining liquid crystal refers to a liquid crystal capable of maintaining a display state without a supply of electric power. Each of electro-optical elements 141 is applied with a voltage depending on a voltage (hereinafter a “scanning voltage”) applied to a related scanning electrode and on a voltage (hereinafter a “data voltage”) applied to a related data electrode. A voltage applied to each electro-optical layer is referred to as a “drive voltage”. Optical characteristics of the electro-optical layers (e.g., optical rotation, light scattering, and the like) vary depending on applied voltages (or supplied power). The electro-optical elements 141 form an image owing to variation of optical characteristics of the electro-optical layers. Basically, one electro-optical unit 141 corresponds to one pixel. In case of a color display which achieves color expression on an RGB color coordinate system, one electro-optical unit 141 corresponds to one of R, G, and B color components included in one pixel.

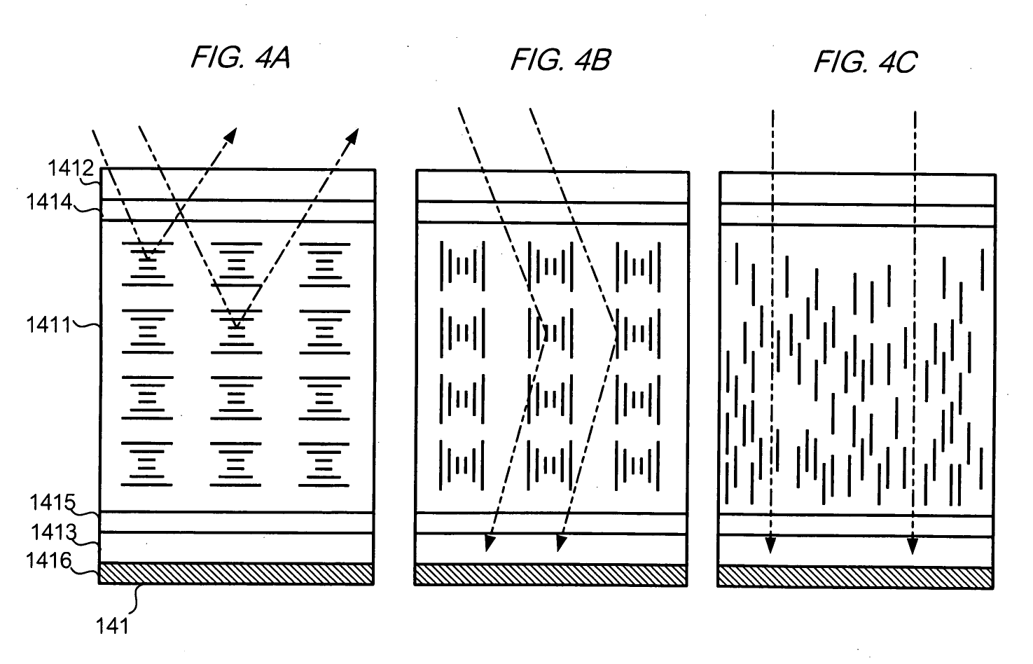

FIGS. 4A-4C show an orientation state of the cholesteric liquid crystal. The electro-optical elements 141 include a cholesteric liquid crystal layer 1411 which is sandwiched between two transparent electrodes 1414 and 1415. Furthermore, the cholesteric liquid crystal layer 1411, the transparent electrodes 1414 and 1415 are sandwiched between two glass substrates 1412 and 1413. An absorption layer 1416 is provided under the glass plate 1413.

The reflectance of the cholesteric liquid crystal layer 1411 depends on an orientation state of the cholesteric liquid crystal molecules. FIG. 4A shows a planer orientation (hereinafter “P-orientation”). When the cholesteric liquid crystal layer 1411 is in the P-orientation, incident light is reflected. In other words, white is displayed. FIG. 4B shows a focal conic orientation (hereinafter “F-orientation”). When the cholesteric liquid crystal layer 1411 is in the F-orientation, incident light is almost transmitted. Since the transparent light is absorbed by the absorption layer 1416, black is displayed. As described above, white, black or an intermediate tone is displayed by controlling the orientation state of the cholesteric liquid crystal layer 1411. Since the cholesteric liquid crystal is one of the bistable display medium, the cholesteric liquid crystal layer can maintain the P-orientation or the F-orientation without application of a voltage. In other words, display is maintained without application of a voltage. To switch between the P-orientation and the F-orientation, the cholesteric liquid crystal layer 1411 has to be changed in homeotropic orientation (hereinafter “H-orientation”). FIG. 4C shows the H-orientation. The H-orientation corresponds to a state in which the spiral structure of cholesteric liquid crystal molecules is broken. In this state, incident light is transmitted. Since the H-orientation is not stable, the cholesteric liquid crystal layer 1411 can maintain the H-orientation by application of a voltage.

1-2. DDS

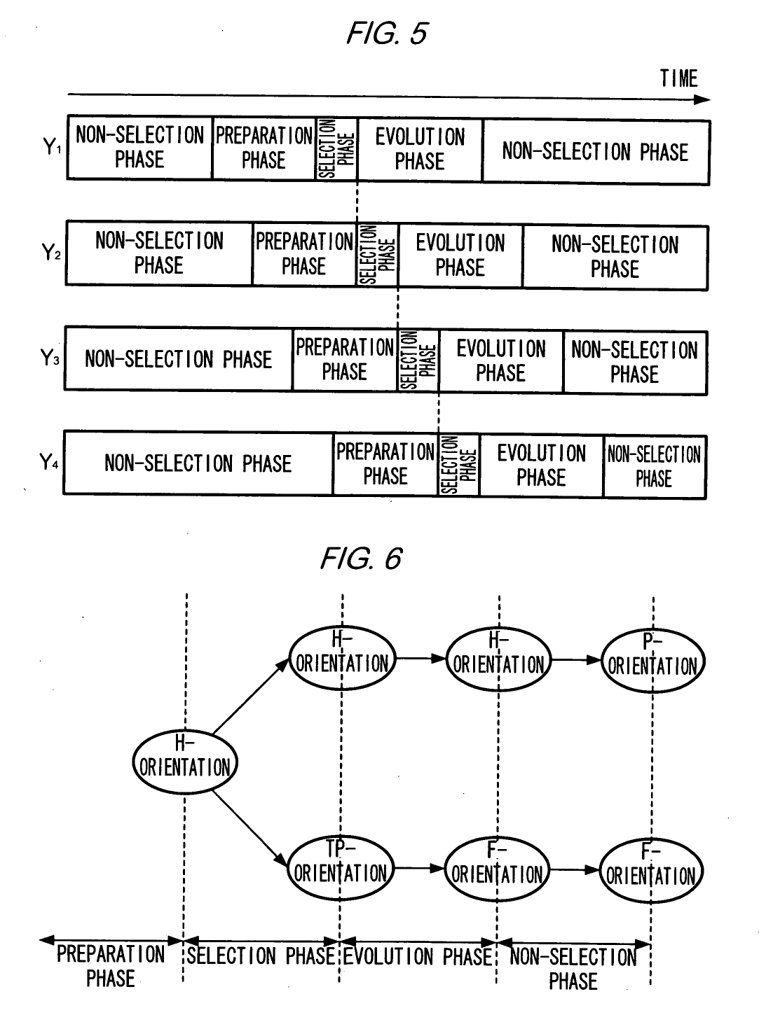

FIG. 5 shows a drive cycle of the DDS. According to the DDS, a drive cycle of electro-optical element 141 is divided into four stages, i.e., a preparation phase (or reset phase), a selection phase, an evolution phase (or hold phase), and a non-selection phase. For pixels corresponding to scanning electrodes Y₁-Yₙ, the selection phase is sequentially allocated to a line. According to the DDS, the orientation state of the cholesteric liquid crystal layer 1411 is determined by the selection phase and its successive evolution phase. Before the DDS is developed, the orientation state of the cholesteric liquid crystal layer 1411 is determined by only the selection phase. Hereinafter, this drive scheme is referred to as a “conventional drive scheme”. For example, according to the conventional drive scheme, a duration of approximately 50 msec. is necessary for the selection phase. Therefore, to rewrite elements of a display having 2000 lines, it takes approximately 100 sec. According to the DDS, the selection phase is shortened to approximately 1 msec. Therefore, the time to rewrite the display elements having 2000 lines is shortened to approximately 2 sec.

FIG. 6 shows transition of orientation states of cholesteric liquid crystal according to the DDS. During the preparation phase, a voltage which causes the cholesteric liquid crystal having P- or F-orientation to transit to H-orientation, is applied. Then, during the selection phase, a voltage which causes the cholesteric liquid crystal to transit to a required state, is applied. The required state corresponds to, for example, white or black for a 2-level display. In other words, the required state is P- or F-orientation for a 2-level display. Here, the voltage which causes the cholesteric liquid crystal to transit to a required state is referred to as a “selection voltage”. In other words, the selection voltage is a drive voltage during the selection phase. By application of the selection voltage, the cholesteric liquid crystal is transited to H- or TP-orientation (transitional planar orientation). The TP-orientation is an intermediate state between the H-orientation and the P-orientation, in which the spiral structure of liquid crystal is slightly relaxed. Then, during the evolution phase, a voltage which causes the cholesteric liquid crystal to maintain the required state, is applied. Here, the voltage during the evolution phase is referred to as “evolution voltage”. The cholesteric liquid crystal having the H-orientation by the selection voltage maintains the H-orientation. The cholesteric liquid crystal having the TP-orientation by the selection voltage transits to the F-orientation. Then, during the non-selection phase, the drive voltage is not applied, though the voltage is not strictly reduced to zero in some cases. The cholesteric liquid crystal having the H-orientation by the evolution voltage transits to the P-orientation, which corresponds to white. The cholesteric liquid crystal having the F-orientation by the evolution voltage maintains the F-orientation, which corresponds to black.

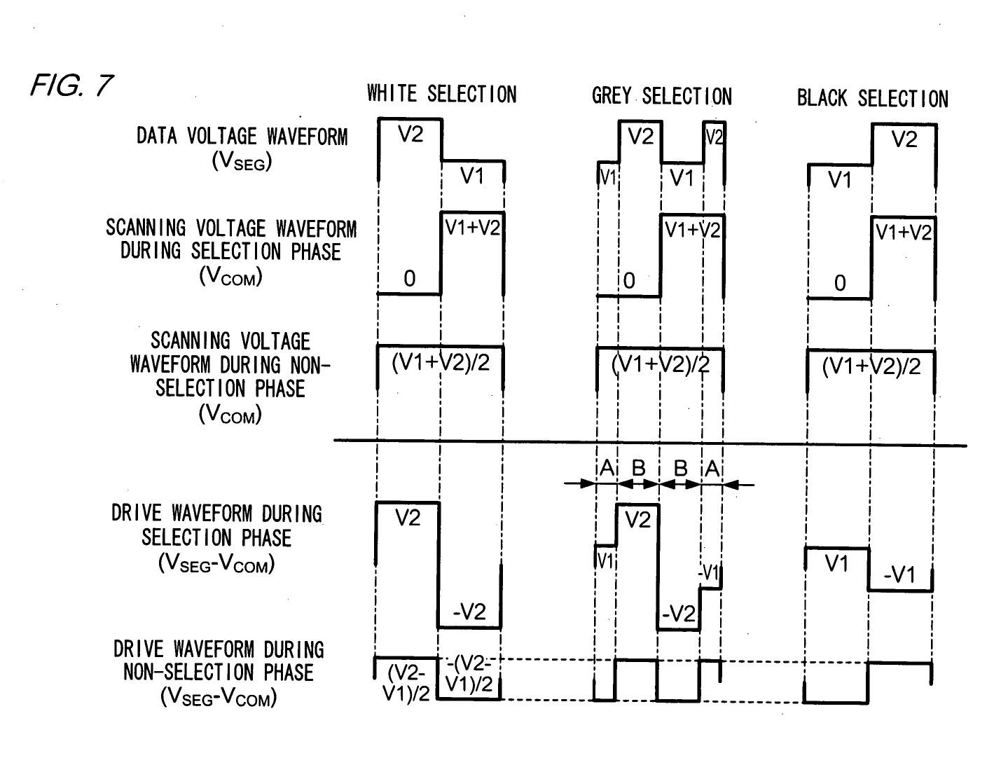

FIG. 7 shows an example of a drive voltage waveform according to the DDS. Here, to avoid degradation of the liquid crystal, positive and negative voltages are applied alternately. In a case of displaying white, the data voltage V_{SEG} is the white selection voltage V₂ in the first half of the selection phase and is the black selection voltage V₁ in the second half (this is similar to the non-selection phase). In this case, the scanning voltage V_{COM} is zero in the first half and is (V₁+V₂) in the second half. Therefore, the drive voltage V_{SEG}-V_{COM} applied to the cholesteric liquid crystal layer 1411 during the selection phase, is V₂ in the first half and is −V₂ in the second half. On the contrary, during the non-selection phase, the scanning voltage V_{COM} is (V₁+V₂)/2. Therefore, the drive voltage V_{SEG}-V_{COM} during the non-selection phase, is (V₂−V₁)/2 in the first half and is −(V₂−V₁)/2 in the second half.

In a case of displaying black, the data voltage V_{SEG} is the black selection voltage V₁ in the first half and is the white selection voltage V₂ in the second half (this is similar to the non-selection phase). The scanning voltage V_{COM} is the same as in the case of displaying white. Therefore, the drive voltage V_{SEG}-V_{COM} during the selection phase, is V₁ in the first half and is −V₁ in the second half. On the contrary, the drive voltage V_{SEG}-V_{COM} during the non-selection phase, is −(V₂−V₁)/2 in the first half and is (V₂−V₁)/2 in the second half.

In a case of displaying a half tone, the data voltage V_{SEG} is a voltage by which the white selection voltage V₂ is applied as a pulse in the drive voltage V_{SEG}-V_{COM}. In other words, in the drive voltage V_{SEG}-V_{COM}, the white selection voltage V₂ is applied as a pulse having a pulse width B against the black selection voltage V₁. By controlling the pulse width B, a multi-level tone is displayed. It is to be noted that the frequency of the signal shown in FIG. 7 may be designed in accordance with a system requirement.

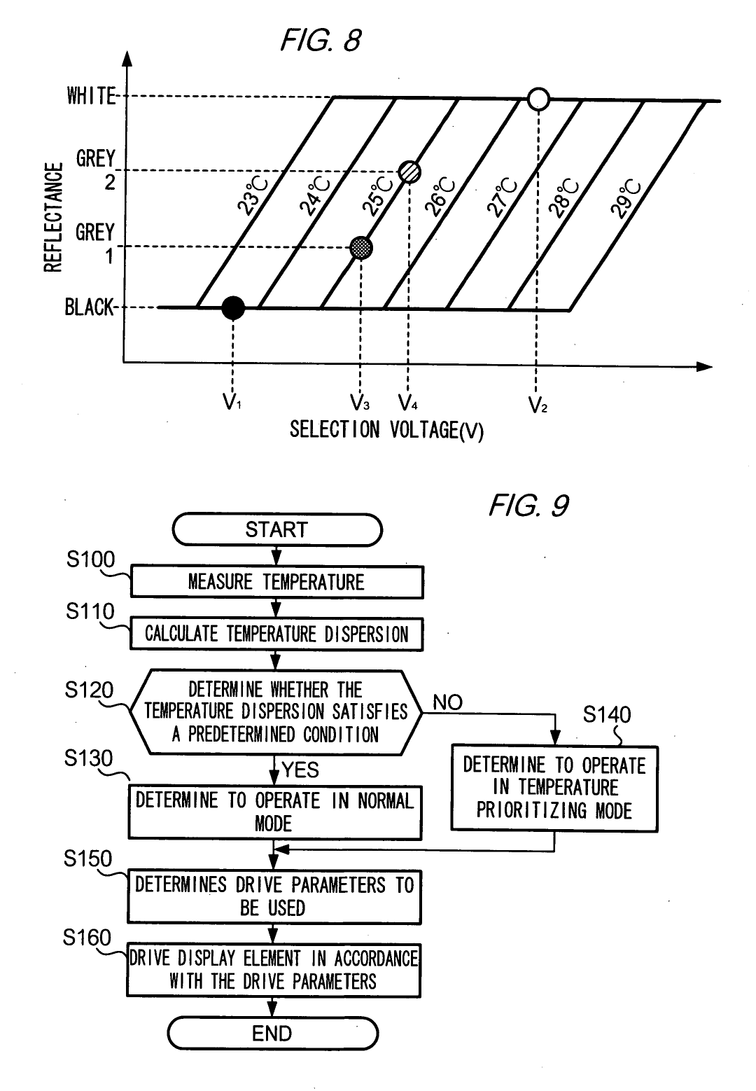

FIG. 8 schematically shows reflectance—selection voltage curves of the cholesteric liquid crystal. In the example shown in FIG. 8, the drive parameters are optimized for 25° C. In FIG. 8, the voltage means an effective voltage in AC signals. FIG. 8 also shows an example of drive parameters for a 4-level tone display. In this case, for example, at 29° C., by application of white voltage V₂, the reflectance corresponds to black. Thus, in this temperature, the drive parameters do not function correctly. On the contrary, in a temperature range of 24-26° C., by application of the white voltage V₂ and the black voltage V₁, the reflectance corresponds to white and black, respectively. Thus, in this temperature range, the drive parameters function correctly. In this case, it is to be noted that “the temperature margin is 24-26° C”. Here, the term “temperature margin” refers to a temperature range in which white and black are displayed correctly. In other words, the term “temperature margin” refers to a temperature range in which two voltage values, each of which is a voltage causing the liquid crystal to be one of predetermined two tones (black and white, for example), are in a range defined by the maximum and the minimum of the selection voltage.

1-3. Operation

FIG. 9 shows a flowchart illustrating an operation of the information processing device 100. The flow shown in FIG. 9 is initiated by a trigger which is, for example, that of a user pushes the rewrite button. In step S100, the CPU 111 measures a temperature. In other words, the CPU 111 obtains via the ADC 114 a temperature signal which is outputted from a temperature sensor 150. The ADC 114 stores a table for converting a voltage of the temperature signal into temperature. The CPU 111 converts the temperature signal into temperature with reference to the table. The CPU 111 adds to the obtained temperature an identifier of the corresponding temperature sensor 150. Then the CPU 111 stores the temperature data in RAM 113.

In step S110, the CPU 111 calculates a temperature dispersion. Here, the “temperature dispersion” is information relating to a distribution or a dispersion of temperature in a display plane of display element 140. The “display plane” is a plane in which the electro-optical element 141 is arranged. For example, the “temperature dispersion” is a difference between a standard temperature of the display element 140 and each measurement point (in other words, a temperature sensor 150). The standard temperature is, for example, an average of temperatures measured by all measurement points. Details of the calculation are as follows. First, the CPU 111 calculates the standard temperature. Then, the CPU 111 sequentially determines one measurement point as a target measurement point. The CPU 111 calculates a difference between the standard temperature and the temperature of the target measurement point. The CPU 111 stores in the RAM 113 the calculated difference as a temperature dispersion. It is to be noted that the standard temperature is not limited to the average temperature of all measurement points. The standard temperature may be a temperature of one specific measurement point, for example.

In step S120, the CPU 111 determines whether the temperature dispersion satisfies a predetermined condition. The condition shows that the temperature dispersion is large. The ROM 112 stores information showing the condition. For example, the condition is that an absolute value of a temperature dispersion of a measurement point is greater than a predetermined threshold. Alternately, the condition may be that a number of measurement points whose temperature dispersion is greater than the threshold is greater than another predetermined threshold. Further alternately, the condition may be that the temperature dispersion ΔT and statistical dispersion σ of the measured temperatures have a predetermined relationship, for example, ΔT>3σ.

The operation mode is determined in response to whether the temperature dispersion satisfies the predetermined condition. Here, description is given for the “normal mode” and the “temperature prioritizing mode”. In the normal mode and the temperature prioritizing mode, the temperature margin is different from each other. A voltage difference M_{S} in the normal mode and a voltage difference M_{E} in the temperature prioritizing mode satisfies a relationship of M_{S}<M_{E}. Here, a voltage difference M in a drive mode is a function of a voltage difference ΔV(=|V₂−V₁|) between the black selection voltage V₁ and the white selection voltage V₂. In other words, in the normal mode and the temperature prioritizing mode, the voltage difference ΔV is different from each other.

If it is determined that the temperature dispersion satisfies the predetermined condition (step S120: YES), the CPU 111 proceeds to the operation in step S130. In step S130, the CPU 111 determines to operate the display driver controller 115 in the normal mode. The CPU 111 outputs to the display driver controller 115 a signal for changing the operation mode to the normal mode.

If it is determined that the temperature dispersion does not satisfy the predetermined condition (step S120: NO), the CPU 111 proceeds to the operation in step S140. In step S140, the CPU 111 determines to operate the display driver controller 115 in the temperature prioritizing mode. The CPU 111 outputs to the display driver controller 115 a signal for changing the operation mode to the temperature prioritizing mode.

In step S150, the display driver controller 115 determines drive parameters (including voltages) to be used, on the basis of the standard temperature and the operation mode. The display driver controller 115 reads from the internal memory drive parameters corresponding to the standard temperature and the determined operation mode. The display driver controller 115 determines to use the read drive parameters. In step S160, the display driver controller 115 controls the display driver circuit 130 in accordance with the drive parameters. The power source circuit 120 applies the voltage to the display driver circuit 130, under the control of the display driver controller 115.

As described above, according to the present embodiment, the display element 140 is driven in the normal mode when the temperature dispersion is less than a threshold while the display element 140 is driven in the temperature prioritizing mode when the temperature dispersion is greater than the threshold. In other words, the temperature margin is expanded when it is necessary. In the normal mode, some characteristics, for example, power consumption, representation of half tone, or the flashing problem, are better resolved than in the temperature prioritizing mode.

### 2. Second Embodiment

Now, a second embodiment of the invention will be described. In the description of the second embodiment, features common with the first embodiment will be omitted. In addition, the same reference numerals will be used for elements common with the first embodiment.

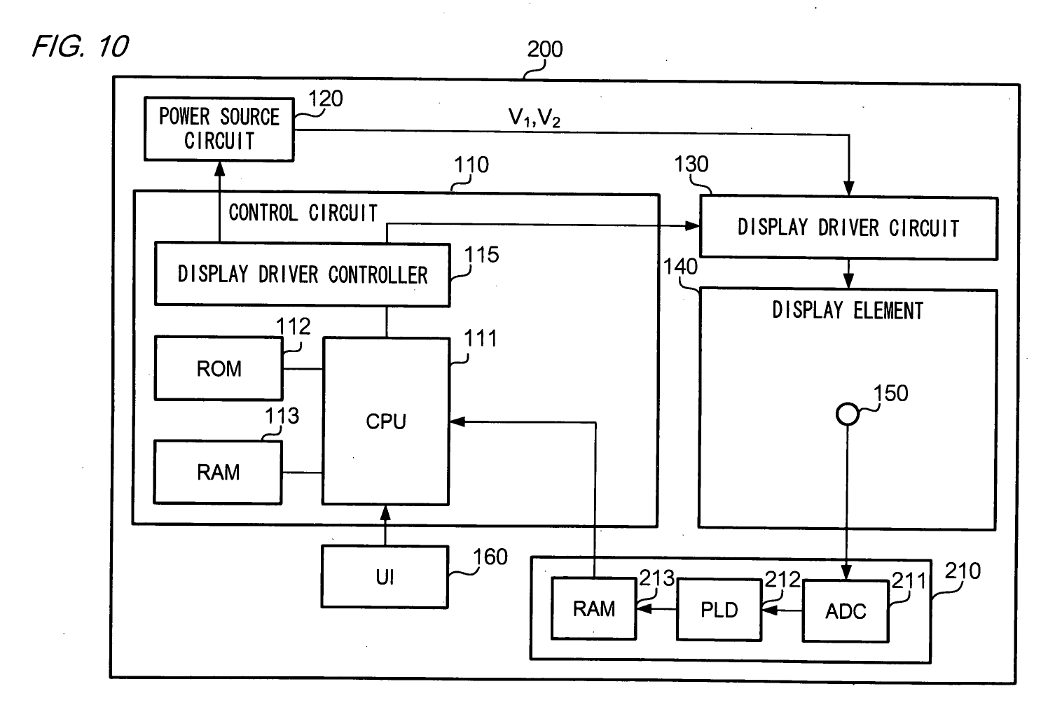

FIG. 10 shows a configuration of an information processing device 200 in accordance with the second embodiment. A temperature data storage circuit 210 stores temperature outputted from the temperature sensor 150. The temperature data storage circuit 210 has the following configuration in detail. An ADC 211 is a circuit which converts an analog signal into a digital signal. A PLD (Programmable Logic Device) 212 is a device that stores in the RAM 213 temperature shown by the digital signal outputted from the ADC 211. To the temperature data storage circuit 210, electric power is supplied via a path different from that for the other circuits (the control circuit 110 or the display driver circuit 130, for example). For the control circuit 110 and the display driver circuit 130, power management for decreasing power consumption is performed. In other words, electric power is supplied in response to the operation of the UI 160 by a user. For example, if a predetermined time (20 sec., for example) has elapsed, the power supply is suspended. If the UI 160 is operated again, the power is supplied again. On the contrary, for the temperature data storage circuit 210, the electric power is supplied as far as a main power supply (not shown in the figures) is maintained. The PLD 212 stores in the RAM 213 temperature data at a predetermined sampling interval.

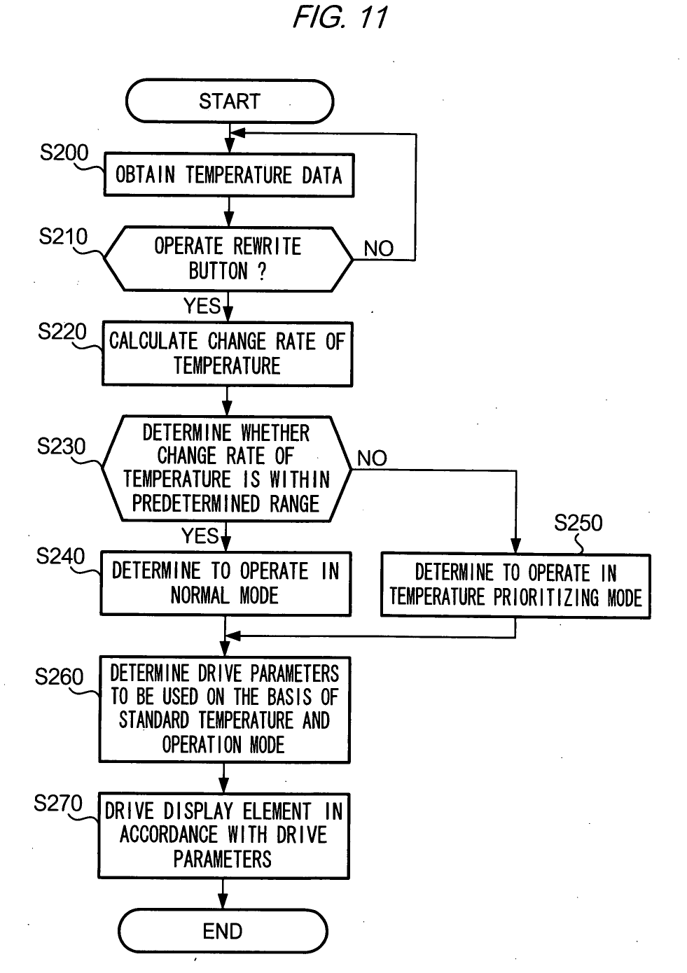

FIG. 11 shows a flowchart illustrating an operation of the information processing device 200. In step S200, the temperature data storage circuit 210 obtains temperature data. Furthermore, the temperature data storage circuit 210 stores the obtained temperature data. In step S210, the CPU 111 determines whether a condition to trigger determining the drive parameter set, is satisfied. In the present embodiment, the condition is that a user operates the rewrite button of the UI 160. If it is determined that the condition is not satisfied (step S210: NO), the CPU 111 waits until the condition is satisfied. If it is determined that the condition is satisfied (step S210: YES), the CPU 111 proceeds to the operation in step S220.

In step S220, the CPU 111 calculates a change rate of temperature. First, the CPU 111 reads temperature data from the RAM 213 of the temperature data storage circuit 213. The temperature data includes time sequential temperatures. For example, the CPU 111 calculates a temperature difference of the newest two data points as the change rate of temperature. Furthermore, the CPU 111 calculates the standard temperature, on the basis of which a drive parameter set is selected. The temperature of the newest data point is used as the standard temperature, for example. Alternatively, a moving average of a predetermined number of the newest data point may be used as the standard temperature.

In step S230, the CPU 111 determines whether the change rate of temperature is within a predetermined range. If it is determined that the change rate of temperature is within the predetermined range (step S230: YES), the CPU 111 proceeds to the operation in step S240. If it is determined that the change rate of temperature is not within the predetermined range (step S230: NO), the CPU 111 proceeds to the operation in step S250.

In step S240, the CPU 111 determines the display driver control circuit 115 to be operated in the normal mode. The CPU 111 outputs to the display driver control circuit 115 a signal for switching the operation mode to the normal mode. In step S250, the CPU 111 determines the display driver control circuit 115 to be operated in the temperature prioritizing mode. The CPU 111 outputs to the display driver control circuit 115 a signal for switching the operation mode to the temperature prioritizing mode. In step S260, the CPU 111 determines drive parameters to be used on the basis of the standard temperature and the operation mode. In step S270, the display driver control circuit 115 controls the display driver circuit 130 and the power source circuit 120 in accordance with the determined drive parameters. The power source circuit 120 applies voltage to the display driver circuit 115 under the control of the display driver control circuit 115.

As described above, according to the present embodiment, the display element 140 is driven in the normal mode when the temperature variation rate is less than a threshold while the display element 140 is driven in the temperature prioritizing mode when the temperature variation rate is greater than the threshold. In other words, the temperature margin is expanded when it is necessary. In the normal mode, some characteristics, for example, power consumption, representation of half tone, or the flashing problem, is better resolved than in the temperature prioritizing mode.

### 3. Third Embodiment

Now, a third embodiment of the invention will be described. In the description of the third embodiment, features common with the first embodiment will be omitted. In addition, the same reference numerals will be used for elements common with the first embodiment.

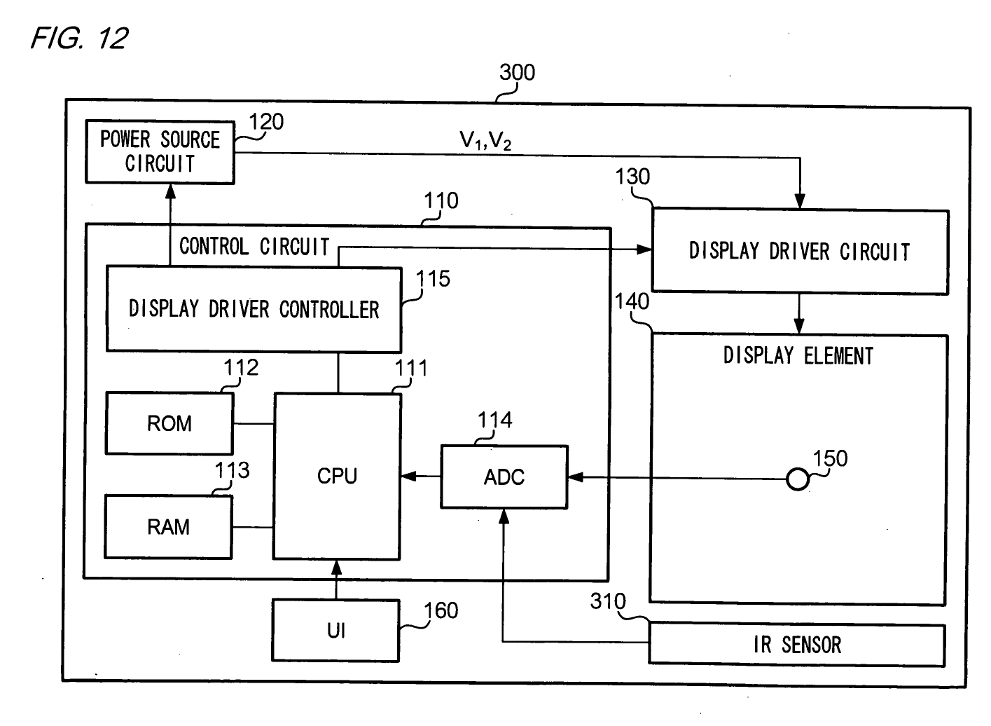

FIG. 12 shows a configuration of an information processing device 300 in accordance with the third embodiment. An IR (infrared rays) sensor 310 is a sensor that detects infrared rays. A thermopile is used as the IR sensor 310. The thermopile is a device that generates electromotive force in response to energy of the received infrared rays. In other words, the thermopile outputs a voltage in response to an intensity of the received infrared rays. The IR sensor 310 is mounted on the information processing device 300 at a position near the display element and the same side of the display element. In addition, the IR sensor 310 is exposed. For example, the IR sensor 310 is mounted on a casing of the information processing device 300 at the same side of the display plane.

An analog signal outputted from the IR sensor 310 is converted into a digital signal by the ADC 114. The ADC 114 outputs to the CPU 111 a signal (IR intensity signal) showing an intensity of the infrared rays. Furthermore, the ADC 114 receives from the temperature sensor 150 an analog signal showing temperature, and converts the analog signal into a digital signal. The ADC 114 outputs to the CPU 111 a signal (temperature signal) showing the temperature. The temperature signal is used to determine the standard temperature.

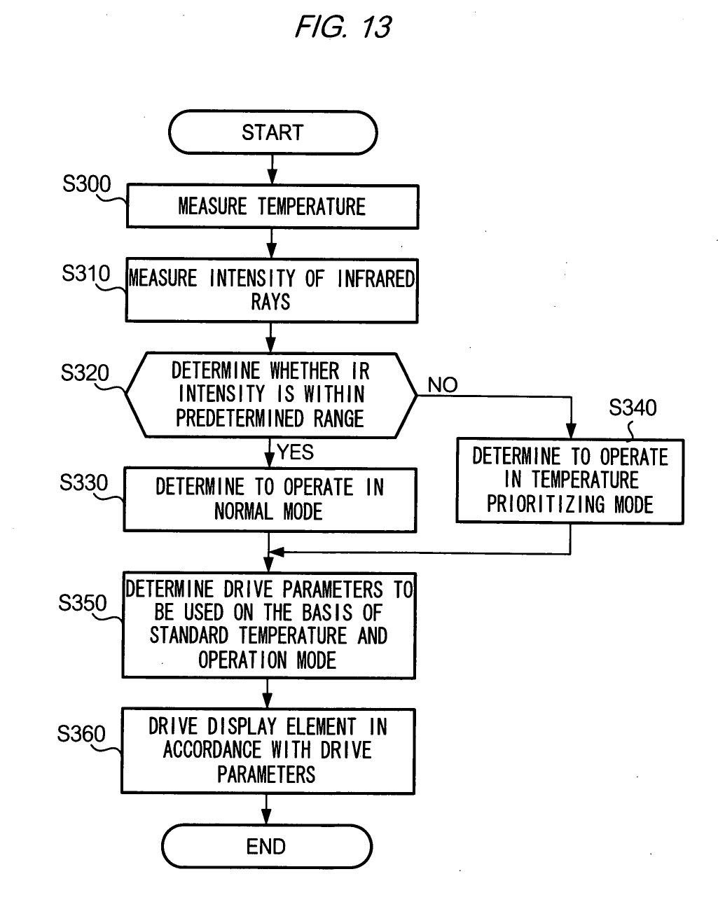

FIG. 13 is a flowchart showing an operation of the information processing device 300. In step S300, the CPU 111 measures the temperature. This processing is carried out in a manner similar to step S100 in FIG. 9. In step S310, the CPU 111 measures an intensity of infrared rays. In other words, the CPU 111 obtains the IR intensity signal from the IR sensor 310 via the ADC 114.

In step S320, the CPU 111 determines whether the IR intensity is within a predetermined range. Here, the “predetermined range” directly corresponds to a condition showing that the IR intensity is greater than a threshold, and indirectly corresponds to a condition showing that a temperature difference between the liquid crystal and the glass substrate is within a predetermined range. The relationship between the IR intensity and the temperature difference will be described later. The ROM 112 stores information relating to the condition, for example, thresholds showing the boundaries of the range.

If it is determined that the IR intensity is within the predetermined range (S320: YES), in step S330, the CPU 111 determines the display driver control circuit to be operated in the normal mode. If it is determined that the IR intensity is not within the predetermined range (S320: NO), in step S340, the CPU 111 determines the display driver control circuit to be operated in the temperature prioritizing mode. The processing in steps S330 and S340 are similar to that in steps S130 and S140 of FIG. 9, respectively. In step S350, the display driver control circuit 115 determines drive parameters to be used, on the basis of the standard temperature and the operation mode. In step S360, the display driver control circuit 115 controls the display driver circuit 130 and the power source circuit 120 in accordance with the determined drive parameters. The power source circuit 120 applies voltage to the display driver circuit 130 under the control of the display driver control circuit 115.

The determination of a drive parameter set as describe above provides the following advantages. If light including far infrared rays such as sunlight and light from a halogen lamp or incandescent lamp, is irradiated on the liquid crystal display panel, the liquid crystal absorbs the far infrared rays. By absorbing the far infrared rays, the liquid crystal generates heat. On the contrary, the glass substrate absorbs far infrared rays less than the liquid crystal and does not generate much heat, compared with the liquid crystal. Thus, if light including far infrared rays is irradiated on the liquid crystal display panel, temperature difference is caused between the liquid crystal and the glass substrate. Since the temperature sensor 150 is mounted on or near the glass substrate, the temperature sensor 150 to measure temperature of the glass substrate. Therefore, if the drive parameters to be used are determined only on the basis of the temperature measured by the temperature sensor 150, there arises a problem in that the measured temperature is the temperature of the glass substrate which is lower than the temperature of the liquid crystal. This situation is similar to a case that drive parameters for 25° C. is used although the temperature of the liquid crystal is 25° C. in FIG. 8, for example. The information processing device 300 prevents the problem by determining drive parameters to be used on the basis of an IR intensity.

### 4. Fourth Embodiment

Now, a fourth embodiment of the invention will be described. In the description of the fourth embodiment, features common with the first embodiment will be omitted. In addition, the same reference numerals will be used for elements common with the first embodiment. In the fourth embodiment, a condition for switching the drive mode is that the temperature of the display element is below a threshold. The reason for using this condition is as follows.

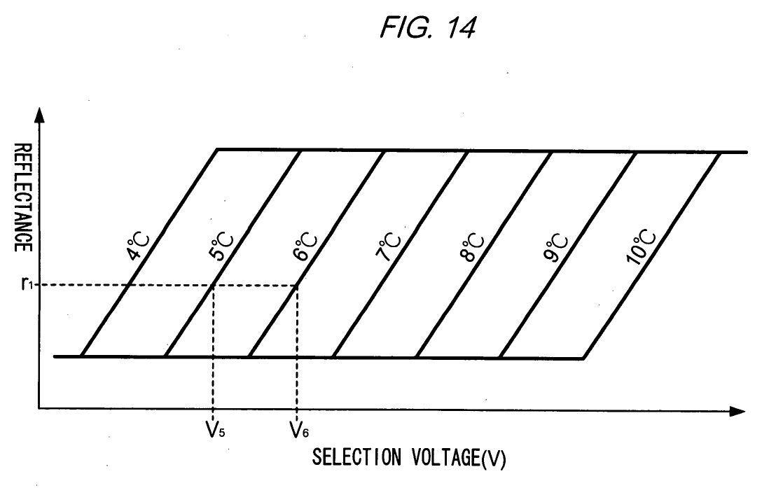

FIG. 14 schematically shows another example of reflectance—selection voltage curves. FIG. 14 shows a temperature dependency in a range of 4-10° C. while FIG. 8 shows a temperature dependency in a range of 23-29° C. In addition, the standard temperature is 5° C. in FIG. 14 while the standard temperature is 25° C. in FIG. 8.

Here, temperature dependency of the reflectance—selection voltage curves is not the same but depends on the standard temperature. For example, a shift width of the reflectance—selection voltage curves per unit temperature is different in a case that the standard temperature is 25° C. and in a case that the standard temperature is 5° C. Here, the “shift width” refers to a difference in selection voltage for the same reflectance. In an example of FIG. 14, for a reflectance r₁, the selection voltage is V₅ for 5° C. and V₆ for 6° C., respectively. That is, the shift width Vₛ is defined as Vₛ=|V₅−V₆|. In a kind of cholesteric liquid crystal, the shift width increases by decreasing the standard temperature. In such a situation, if a temperature dispersion or a rapid change in temperature arises, it badly affects the display characteristics. In the present embodiment, the operation mode is switched from the normal mode to the temperature prioritizing mode if the temperature of the display element becomes less than a threshold. Thus, bad effects of temperature dispersion or rapid change in temperature are prevented.

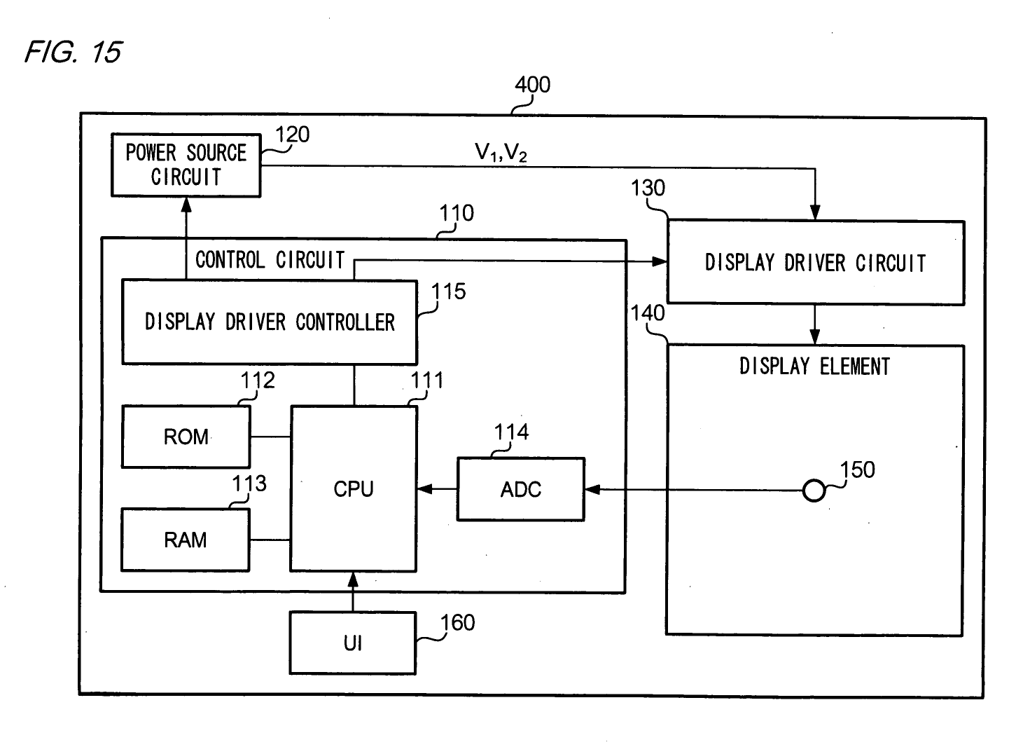

FIG. 15 shows a configuration of an information processing device 400 in accordance with the fourth embodiment. The difference between the information processing device 400 and the information processing device 100 is that the information processing device 400 has a single temperature sensor 150. It is to be noted that the information processing device 400 may have plural temperature sensors.

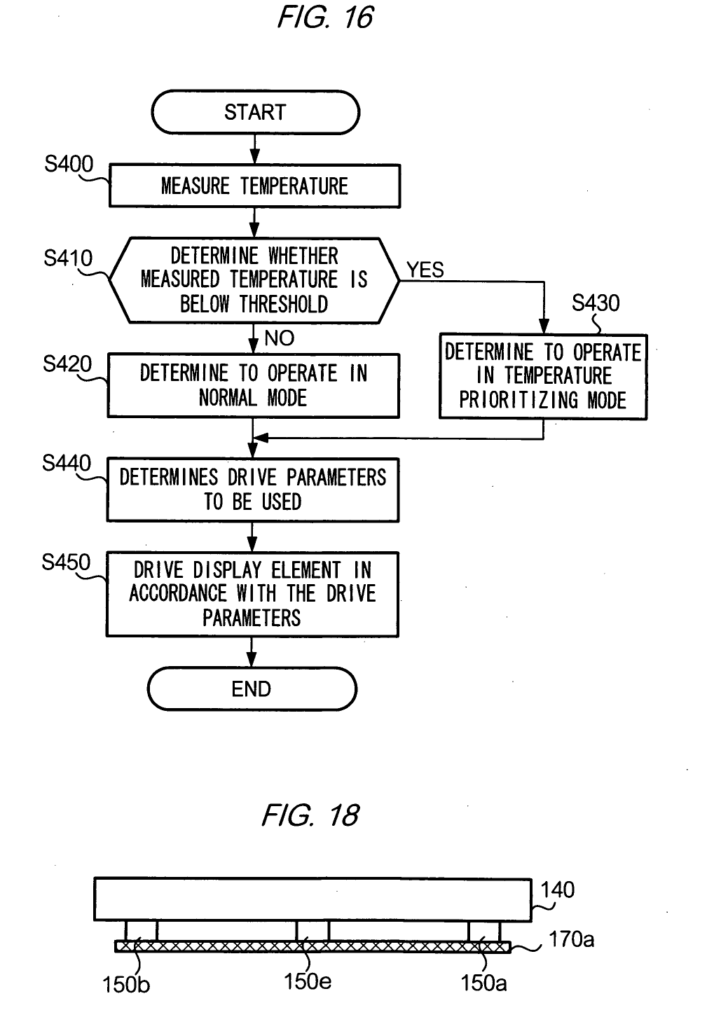

FIG. 16 is a flowchart showing an operation of the information processing device 400. In step S400, the CPU 111 measures temperature. This processing is carried out similarly to step S100 in FIG. 9. In step S410, the CPU 111 determines whether the measured temperature is below a threshold. The ROM 112 stores the threshold prior to the operation.

If it is determined that the measured temperature is not below the threshold (S410: NO), the CPU 111 proceeds to the operation in step S420. If it is determined that the measured temperature is below the threshold (S410: YES), the CPU 111 proceeds to the operation in step S430. The processing in steps S420-S450 are carried out similarly to those in steps S130-S160 of FIG. 9.

### 5. Fifth Embodiment

Now, a fifth embodiment of the invention will be described. In the description of the fifth embodiment, features common with the first embodiment will be omitted. In addition, the same reference numerals will be used for elements common with the first embodiment. In the fifth embodiment, a radiation sheet is pasted on the display element 140. In the description given below, the radiation sheet is applied to the information processing device 100 of the first embodiment. However, the radiation sheet may be applied to another embodiment. The radiation sheet functions as a heat conductor.

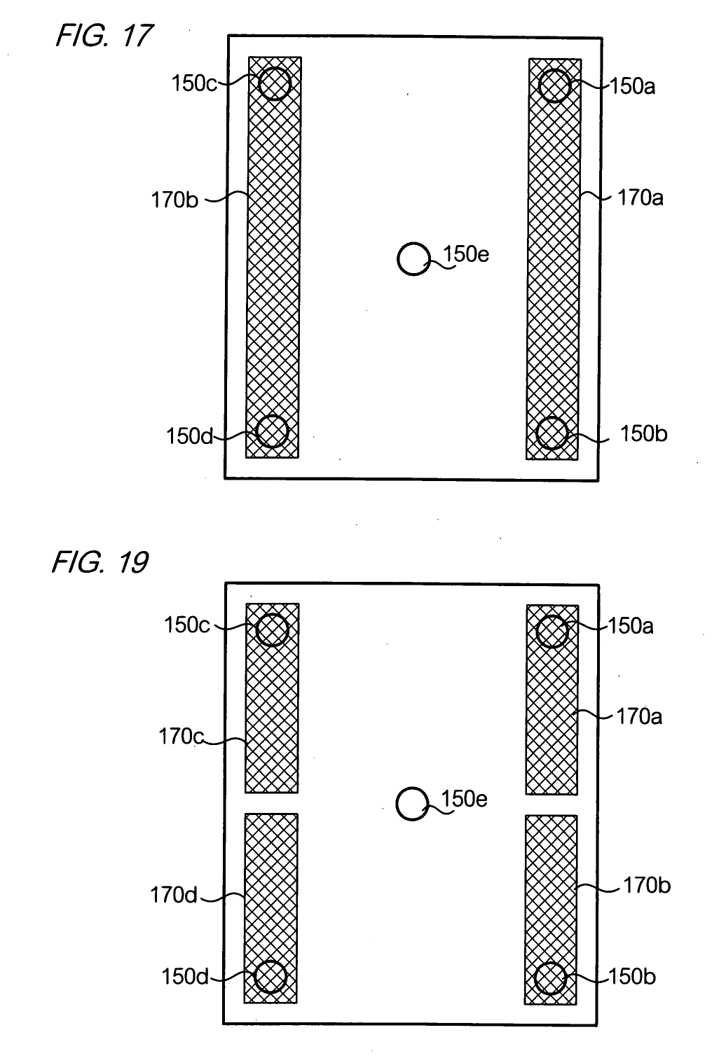

FIG. 17 schematically shows a lower side view of the display element 140. FIG. 18 schematically shows a right side view of the display element 140. In the present embodiment, the information processing device 100 has five temperature sensors 150. Specifically, four temperature sensors 150a-150d are pasted near the edge of the lower plane of the absorption layer 1416 (shown in FIG. 4), and a temperature sensor 150e is pasted approximately at the center of the lower plane. Furthermore, two square-shaped radiation sheets 170a and 170b are pasted on the lower plane of the absorption layer 1416. Each of the radiation sheets 170a and 170b is pasted so as to cover two temperature sensors. Here, thermal conductivity of the air around the temperature sensor 150 is approximately 0.02 W/mK, and thermal conductivity of the glass substrate of the display element 140 is approximately 1 W/mK. Therefore, it is preferred that thermal conductivity of the radiation sheet 170 is approximately 200-300 W/mK. In the present embodiment, the radiation sheet 170 includes a so-called graphite sheet, which consists of carbon molecules having a layered structure. The graphite sheet has characteristics in that level thermal conductivity is higher than perpendicular thermal conductivity. Therefore, it is preferable to conduct heat to the temperature sensors distributed on a plane. Thus, to cover the temperature sensors by the radiation sheet, the heat is conducted effectively. It is to be noted that the radiation sheet may include other materials, for example, copper foil, as far as its thermal conductivity is 200-300 W/mK.

Advantages of using the radiation sheet is as follows. In the present embodiment, a thermistor is used to measure the temperature. However, an area where a thermistor can measure temperature is narrower than the area of the display element 140. To measure the temperature for the whole plane of the display element 140, a large number of thermistors are necessary. In addition, a large number of ADC circuits are also necessary relative to the thermistors. This makes the device configuration too complex. According to the present embodiment using the radiation sheet, heat generated at a position apart from the thermistor is conducted to the thermistor. Therefore, the temperature is effectively measured by smaller number of thermistors.

The operation of the information processing device 100 of the present embodiment is the same as that of FIG. 9. In the present embodiment, the standard temperature is temperature measured by the temperature sensor 150e. The temperature sensor 150e is pasted approximately at the center of the display element 140, in other words, at a position where a finger or a hand of a user would not normally come into contact with the temperature sensor 150e. On the contrary, the temperature sensors 150a-150d are pasted near the edge of the display element 140, in other words, at a position where a finger or a hand of a user easily comes into contact with the temperature sensor 150e. The temperature sensors 150a and 150b, and temperature sensors 150c and 150d are covered by the radiation sheets 170a and 170b, respectively. Therefore, the temperature at the edge of the display element 140 is measured effectively. According to the arrangement of the temperature sensors and the radiation sheets, the temperature dispersion is measured more effectively and more accurately. Thus, according to the present embodiment, if a finger or a hand of a user touches the display element 140 and the temperature dispersion arises, the drive parameters to be used are determined on the basis of the temperature dispersion. In other words, white and black is displayed better.

It is to be noted that the number and the arrangement of the temperature sensor 150 is not restricted to an example shown in FIG. 17. In the example shown in FIG. 17, at least one temperature sensor (the temperature sensor 150e) is arranged at a position whose distance from the edge of the lower plane is greater than a predetermined threshold. Furthermore, at least a part of other temperature sensors (the temperature sensors 150a-150d) is arranged at a position whose distance from the edge of the lower plane is less than the threshold. However, the temperature sensors 150 may be arranged in other ways as far as the temperature sensors can measure the standard temperature and other temperatures. The temperature sensor is mounted on a plane of one of two substrates which sandwich the display element. Plural temperature sensors may be mounted on the lower plane (specifically, the lower plane of the absorption layer 1416) at an interval.

In the present embodiment, the standard temperature is temperature measured by a temperature sensor placed approximately at the center of the display element. However, the standard temperature is not restricted to this temperature. The standard temperature may be another temperature, for example, an average temperature measured by all temperature sensors including the temperature sensor 150e.

FIG. 19 shows another example of an arrangement of the radiation sheets. As shown in FIG. 19, the number and the arrangement of the radiation sheet is not restricted to an example shown in FIG. 17. In an example shown in FIG. 19, the display element 140 has four radiation sheets 170c-170f Each of the radiation sheets 170c-170f is arranged so as to cover a single temperature sensor. Furthermore, the radiation sheets 170c-170f are arranged so as not to overlap each other. According to an example shown in FIG. 19, peripheral region of the display element is divided into four regions and the temperature is measured for each region. Therefore, the temperature dispersion is measured more effectively and more accurately. Thus, the shape, size, and region that a radiation sheet covers may be designed according to a suitable configuration or use of the information processing device 100, for example, a position easy to touch, would be considered. The radiation sheet is pasted on the same plane as the temperature sensor. Each radiation sheet may be arranged so as to cover at least one temperature sensor and so as not to overlap each other.

### 6. Further Embodiments

The invention is not restricted to the above described embodiments, and may be practiced in various forms of modifications as follows. Although the information processing device 100 has a single temperature prioritizing mode in the first embodiment, the information processing device 100 may have plural temperature prioritizing modes. In this case, a single temperature mode, in other words, a temperature margin, is determined to be used, on the basis of the temperature dispersion. Details are as follows. The display driver circuit 130 stores a drive parameter set for a hot spot and a drive parameter set for a cold spot. The term “hot spot” refers to a measurement point whose temperature is higher than the standard temperature and whose temperature dispersion is greater than a threshold. The term “cold spot” refers to a measurement point whose temperature is lower than the standard temperature and whose temperature dispersion is greater than the threshold. If it is determined that the temperature dispersion satisfies the condition (in other words, the temperature dispersion is greater than the threshold), the CPU 111 determines whether the measurement point is a hot spot or a cold spot. If it is determined that the measurement point is a hot spot, a drive parameter set for the hot spot is determined to be used, while if it is determined that the measurement point is a cold spot, a drive parameter set for the cold spot is determined to be used. Here, a drive parameter set for the hot spot includes a white selection voltage which is higher than the white selection voltage V₂ in FIG. 8. The black selection voltage V₁ may be maintained or may be shifted to higher voltage (corresponding to higher temperature). A drive parameter set for the cold spot includes a black selection voltage which is lower than the black selection voltage V₁ in FIG. 8. The white selection voltage V₂ may be maintained or may be shifted to lower voltage (corresponding to lower temperature).

In the first embodiment, the information processing device 100 has three temperature sensors 150 in FIG. 1. The number and arrangement of the temperature sensor 150 are not restricted to an example shown in FIG. 1. To measure more local temperature dispersion, it is better to increase the number of the temperature sensor 150. To decrease cost, it is better to decrease the number of the temperature sensor 150. The information processing device 100 may have at least two temperature sensors 150. If the information processing device 100 has only two temperature sensors 150, temperature measured by one temperature sensor 150 may be sued as the standard temperature. This is similar to other embodiments.

Although the information processing device 100 has a single temperature prioritizing mode in the first embodiment, the information processing device 100 may have plural temperature prioritizing modes. In this case, a single temperature mode, in other words, a temperature margin, is determined to be used, on the basis of the temperature variation. Details are as follows. The display driver circuit 130 stores a drive parameter set for temperature increasing and a drive parameter set for temperature decreasing. The term “temperature increasing” refers to a state when the temperature variation is positive. The term “temperature decreasing” refers to a state when the temperature variation is negative. If it is determined that the temperature variation is above a predetermined range (in other words, the temperature variation is greater than a threshold), the CPU 111 determines whether the temperature is increasing or decreasing. If it is determined that the temperature is increasing, a drive parameter set for temperature increasing is determined to be used, while if it is determined that the temperature is decreasing, a drive parameter set for temperature decreasing is determined to be used. Here, a drive parameter set for temperature decreasing includes a white selection voltage which is higher than the white selection voltage V₂ in FIG. 8. The black selection voltage V₁ may be maintained or may be shifted to higher voltage (corresponding to higher temperature). A drive parameter set for temperature increasing includes a black selection voltage which is lower than the black selection voltage V₁ in FIG. 8. The white selection voltage V₂ may be maintained or may be shifted to lower voltage (corresponding to lower temperature).

The reason why such drive parameter sets are used is as follows. The temperature sensor is mounted on a glass substrate which sandwiches the liquid crystal layer. Since the glass substrate is located outside the liquid crystal, temperature of the glass substrate follows environment temperature faster than the liquid crystal. In other words, it may be considered that the temperature variation of the liquid crystal has delay from the temperature variation of the glass substrate. Therefore, if the temperature measured by the temperature sensor is increasing, the actual temperature of the liquid crystal is lower than the measured temperature. On the contrary, if the temperature measured by the temperature sensor is decreasing, the actual temperature of the liquid crystal is higher than the measured temperature.

In addition, in the second embodiment, although the information processing device 200 has a single temperature sensor in FIG. 10, the number and the arrangement of the temperature sensor 150 is not restricted to an example shown in FIG. 10. The information processing device 200 may have plural temperature sensors 150. In this case, the operation of FIG. 11 may be triggered if it is determined that the measured temperature variation is above a predetermined range at a predetermined number (for example, at least one, or for another example, at least the half) of temperature sensors.

In the above embodiments, the voltage difference ΔV is different between the standard mode and the temperature prioritizing mode. However, it is not necessary for the voltage difference ΔV of the standard mode and the temperature prioritizing mode to be different from each other. The voltage difference ΔV may be the same as far as temperature range of the two operation modes is different from each other. The information processing device may have at least two operation modes (a first drive mode and a second drive mode), each of which has different temperature margin which is a temperature range within which the electro-optical layer can represent two tones. For example, the temperature margin for the normal mode and the temperature prioritizing mode may be 24-26° C. and 26-28° C., respectively.

The operation mode is determined on the basis of spacial temperature variation (dispersion) in the first embodiment and on the basis of temporal temperature variation in the second embodiment. The first embodiment and the second embodiment may be combined. In other words, it may be determined whether at least one of the spacial temperature variation and the temporal temperature variation is above a predetermined range. If it is determined that at least one of the spacial temperature variation and the temporal temperature variation is above the predetermined range, the temperature prioritizing mode is determined to be used.

In the above embodiment, the DDS is used as a drive scheme for the display element 140. However, the drive scheme is not restricted to the DDS. In addition, in a case of using the DDS, the drive waveform is not restricted to an example shown in FIG. 7. The data voltage may be applied by a drive waveform which is divided into a plurality of stages including a selection phase during which a selection voltage that determines the orientation state of the memorable liquid crystal molecules is applied. Alternatively, the display driver may employ the conventional drive scheme.

In the above embodiments, the display element 140 includes cholesteric liquid crystal which is an example of memorable display medium. However, the display element may employ other display medium than cholesteric liquid crystal. Furthermore, in the above embodiments, the temperature sensor 150 includes a thermistor. However, the temperature sensor 150 may include other device than the thermistor, for example, a thermocouple or a noncontact radiation thermometer.

In the above embodiments, temperature dependency of the reflectance—selection voltage curves is described with reference to FIG. 8. However, the temperature dependency is not restricted to an example shown in FIG. 8. According to another temperature dependency, the selection voltage may be shifted to lower with increasing temperature, for example.

What is claimed is:

1. A display driver for driving a display element including an electro-optical layer to which a drive voltage is applied, the drive voltage being a voltage corresponding to a scanning voltage and a data voltage, the scanning voltage being a voltage applied to a scanning electrode, the data voltage being a voltage applied to a data electrode, the display driver comprising:
a display driver circuit configured to apply the drive voltage to the electro-optical layer, the drive voltage corresponding to one of at least two operation modes including a first drive mode and a second drive mode, the first drive mode having a first temperature range for representing two tones, the second drive mode having a second temperature range for representing two tones, the first temperature range and the second temperature range being different from each other;
an input interface configured to input temperature information, the temperature information being information relating to temperature of the display element; and
an operation mode determining unit configured to determine operation mode of the display driver circuit on the basis of the temperature information.

2. The display driver according to claim 1,
wherein the temperature information includes temperature dispersion showing a dispersion of temperature within a predetermined area of the display element.

3. The display driver according to claim 2,
wherein the second temperature range is wider than the first temperature range;
the display driver further includes a condition determining unit configured to determine whether the temperature dispersion included in the temperature information is greater than a threshold; and
the operation mode determining unit is configured to determine that the operation mode of the display driver circuit is the second drive mode in a case that the condition determining unit determines that the temperature dispersion is greater than the threshold.

4. The display driver according to claim 2,
wherein the maximum temperature in the second temperature range is greater than that in the first temperature range;
the display driver further includes a condition determining unit configured to determine whether the temperature dispersion included in the temperature information satisfies a condition, the condition showing the temperature dispersion is higher than a threshold and temperature of a region where the temperature dispersion is higher than the threshold is higher than the temperature of the periphery of the region; and
the operation mode determining unit is configured to determine that the operation mode of the display driver circuit is the second drive mode in a case that the condition determining unit determines that the temperature dispersion satisfies the condition.

5. The display driver according to claim 2,
wherein the minimum temperature in the second temperature range is less than that in the first temperature range;
the display driver further includes a condition determining unit configured to determine whether the temperature dispersion included in the temperature information satisfies a condition, the condition showing the temperature dispersion is higher than a threshold and temperature of a region where the temperature dispersion is higher than the threshold is lower than the temperature of the periphery of the region; and
the operation mode determining unit is configured to determine that the operation mode of the display driver circuit is the second drive mode in a case that the condition determining unit determines that the temperature dispersion satisfies the condition.

6. The display driver according to claim 2, further comprising:
an IR information input interface configured to input IR information showing an intensity of infrared rays irradiated onto the display element; and
a condition determining unit configured to determine whether the IR intensity included in the IR information satisfies a condition, the condition showing that the IR intensity is higher than a predetermined threshold,
wherein the maximum temperature of the second temperature range is higher than that in the first temperature range; and
the operation mode determining unit is configured to determine that the operation mode of the display driver circuit is the second drive mode in a case that the condition determining unit determines that the IR intensity satisfies the condition.

7. The display driver according to claim 2, further comprising:
a standard temperature determining unit configured to determine a standard temperature, the standard temperature being standard on the basis of which the drive voltage is determined; and
a parameter memory configured to store a plurality of parameter sets, each of the plurality of parameter set defining the drive voltage at a certain temperature in an operation mode,
wherein the display driver circuit is configured to apply the drive voltage in accordance with one of the plurality of parameter sets, the one parameter set being determined on the basis of the standard temperature and the operation mode determined by the operation mode determining unit.

8. The display driver according to claim 1,
wherein the electro-optical layer includes image-retaining liquid crystal molecules that represent a tone in response to orientation state of the image-retaining liquid crystal molecules;
the display driver circuit is configured to apply the drive voltage by dividing the drive voltage into a plurality of stages including a selection phase during which a selection voltage that determines the orientation state of the image-retaining liquid crystal molecules is applied,
the range of the selection voltage in the first drive mode and in the second drive mode is different from each other.

9. The display driver according to claim 1,
wherein the temperature information includes temperature variation showing time dependency of the temperature of the display element.

10. The display driver according to claim 9,
wherein the maximum temperature in the second temperature range is higher than that in the first temperature range;
the display driver further includes a condition determining unit configured to determine whether the temperature variation included in the temperature information satisfies a condition, the condition showing that the temperature of the display element decreases; and
the operation mode determining unit is configured to determine that the operation mode of the display driver circuit is the second drive mode in a case that the condition determining unit determines that the temperature variation satisfies the condition.

11. The display driver according to claim 9,
wherein the minimum temperature in the second temperature range is lower than that in the first temperature range;
the display driver further includes a condition determining unit configured to determine whether the temperature variation included in the temperature information satisfies a condition, the condition showing that the temperature of the display element increases; and
the operation mode determining unit is configured to determine that the operation mode of the display driver circuit is the second drive mode in a case that the condition determining unit determines that the temperature variation satisfies the condition.

12. The display driver according to claim 1,
wherein the temperature information includes the temperature of the display element;
the display driver further includes a threshold memory configured to store a threshold showing the temperature at which the operation mode is switched;
the operation mode determining unit is configured to determine that the operation mode of the display driver circuit is the second drive mode in a case that the temperature shown by the temperature information is lower than the threshold.

13. An electronic device, comprising:
a display element including an electro-optical layer to which a drive voltage is applied, the drive voltage being a voltage corresponding to a scanning voltage and a data voltage, the scanning voltage being a voltage applied to a scanning electrode, the data voltage being a voltage applied to a data electrode, the display driver comprising:
a display driver circuit configured to apply the drive voltage to the electro-optical layer, the drive voltage corresponding to one of at least two operation modes including a first drive mode and a second drive mode, the first drive mode having a first temperature range for representing two tones, the second drive mode having a second temperature range for representing two tones, the first temperature range and the second temperature range being different from each other;
an input interface configured to input temperature information, the temperature information being information relating to temperature of the display element; and
an operation mode determining unit configured to determine an operation mode of the display driver circuit on the basis of the temperature information.

14. The electronic device according to claim 13, further comprising:
two glass substrates configured to sandwich the electro-optical layer;
a plurality of temperature sensors mounted on a plane of at least one of the two glass substrates;
at least one radiation sheet pasted on the same plane as the temperature sensors.

15. The electronic device according to claim 14,
wherein the plurality of temperature sensors are laid out at intervals;
the electronic device includes a plurality of radiation sheets, each of which covers at least one of the temperature sensors, and is arranged so as not to overlap each other.

16. The electronic device according to claim 14,
wherein the radiation sheet includes a graphite sheet.

17. The electronic device according to claim 14,
wherein at least one of the temperature sensors is arranged at a position whose distance from the edge of the plane is greater than a threshold;
some of the temperature sensors other than the at least one of the temperature sensors is arranged at a position whose distance from the edge of the plane is less than a threshold; and
the temperature information shows temperature difference between the at least one of the temperature sensors and some of the temperature sensors.
